(19) United States
(12) Patent Application Publication
(10) Pub. No.: US 2016/0200075 A1
(43) Pub. Date: Jul. 14, 2016

(54) BLANK, IN PARTICULAR FOR PERMANENTLY CLOSING HOLES

(71) Applicant: TESA SE, Norderstedt (DE)

(72) Inventors: SEBASTIAN DIETZE, Hamburg (DE); KATJA MEYER, Hamburg (DE); UWE SCHÜMANN, Pinneberg (DE); MATTHIAS SEIBERT, Hamburg (DE)

(73) Assignee: Tesa SE, Norderstedt (DE)

(21) Appl. No.: 14/913,411

(22) PCT Filed: Jul. 23, 2014
(86) PCT No.: PCT/EP2014/065809

§ 371 Date: Feb. 22, 2016

(30) Foreign Application Priority Data
Aug. 23, 2013 (DE) 10 2013 216 782.2

(51) Int. Cl. B32B 15/092; B32B 37/12; C09J 113/00; C09J 163/00; B32B 7/12; B32B 15/20

(52) U.S. Cl. CPC B32B 15/092; B32B 7/12; B32B 15/20; C09J 113/00; C09J 163/00; B32B 37/12; B32B 2255/06; B32B 2255/26; B32B 2255/10; B32B 2556/00

(57) ABSTRACT

A blank and/or diecut permanently closes of holes in one or more metal sheets and/or plastics parts. The blank and/or diecut comprises a carrier having at least one thermosetting plastic, wherein the diecut is self-adhesive at least prior to curing.

The present invention relates to a diecut especially for the permanent closing of holes which are located preferably in metal sheets or in plastics parts, and also to a method for permanently closing holes.

In the fabrication of relatively complex structures from metal sheets and/or plastics, constructional dictates make it impossible to avoid having to cut holes into the sheets or plastics, in order to gain access to cavities situated behind them, whether for the purpose of painting or for the purpose of welding.

When the desired operation has been concluded, these holes are usually no longer needed, and are often in fact disruptive, since they allow the passage of air, atmospheric moisture, or water into the structure, which may lead, for example, to processes of oxidation (rust).

One simple solution to avoiding these problems is to close the holes again after use.

Particularly in the production of modern vehicles such as watercraft, land vehicles (trucks, automobiles, etc.), air vehicles, space vehicles, and combinations thereof, such as amphibious vehicles, for example, it is inevitable that during assembly, in numerous individual parts made from metal sheets or plastics, holes of different sizes are required. The hole diameters are customarily between 5 and 50 mm. In subsequent operation, many of these holes must be given airtight and in particular watertight closure again, in order to prevent said corrosive attacks.

Another requirement is to achieve a considerable improvement in the soundproofing of the passenger interior through the closing of the holes.

The problems underlying the invention, and also the solution to these problems, are described below using the body of an automobile as an example. This expressly does not restrict the concept of the invention to said application. Said application is part of the technical field in which the invention is manifested to particular advantage.

If from this point on there is reference to use in a vehicle body, the skilled person reads this as embracing all other application possibilities as well as a vehicle body.

In automobile construction, holes must be made, by punching, for instance, at various locations in the vehicle body. Generally this is done as part of the operation of punching and forming the individual sheet-metal or aluminum parts; additionally, holes may also be drilled in plastics components. Subsequently, by means of a variety of joining processes, the individual metal parts are connected with one another, and the bodyshell is formed. The uses of the holes, openings, or passages in this bodyshell include their use as paint drainage holes (for cathodic electrocoat materials, for example), wax injection holes, wax drainage holes, holes for later screw-mounting operations in assembly, or for cable passages. After the cathodic electrocoat material has dried, many of these holes must be closed again, or else must be closed after the final clearcoat operation (in which case hole closure would take place in the assembly process).

There are many possible reasons why it is necessary for a hole to be closed, examples being:
moisture
acoustics
corrosion prevention

Generally speaking, the holes or openings are closed by means of injection-molded parts (plugs) made from various polymers manufactured according to the profile of requirements. These may be, for example, plugs made from PET, ABS, PP, PVC, EPDM, PA, and other commercial polymers, or else combinations of the stated materials and customary commercial polymeric substrates not listed here. Also in use are materials which possess a glass fiber fraction; also conceivable are carbon fibers, which strengthen the plug against being punctured, for example. In principle all common polymeric substrates are possible, provided they offer particular parameters in relation to paintability, temperature stability, and dimensional stability under climatic conditions, and also fulfill a certain economy in the plug manufacturing process.

At the present time, vehicle bodywork holes are generally closed using plastics plugs which on the one hand, in a particular case, do not securely close the hole, and on the other hand are comparatively complicated and expensive to produce.

Where requirements of sealing are particularly exacting, the plugs are provided with rings made of hotmelt adhesives. EP 0 911 132 B1 discloses an improved production method for such plugs. EP 1 265 738 B1 describes expanding preformed plugs.

Each size of hole requires a specific plug adapted to the hole size. This entails high logistical and administrative effort for the consumer of the plugs.

On the production line it is necessary accordingly to hold a large number of plugs of different sizes in individually assigned storage crates.

An additional problem is that diecutting burrs cannot be reliably bridged. Moreover, plugs require a sufficient planar support area and cannot be installed in corners.

Also suitable for this purpose are adhesive tapes, which are cut to length or punched in accordance with the hole size. Adhesive tapes as well, however, do not always do justice to the increasingly high market requirements.

An advantage of the adhesive tapes is that although they are able to bridge diecutting burrs or adverse geometries, they nevertheless have to be flexible.

DE 10 2008 050 772 A1 describes an adhesive element of this kind based on butyl rubber in conjunction with an anticorrosion layer. This element, although flexible, is nevertheless easily punctured by sharp objects. With a construction of this kind, particularly in the region of the underbody of the vehicle, additional protection is needed from damage, in the form of an underbody coating. Another weak point of diecut parts in the underbody region is that they may become partly detached, and no longer able to afford protection from corrosion, as a result of specific pressure, as may occur, for example, as a result of a high-heel shoe.

As already described in WO 2006/053827 A1, systems suitable for the specific closing of holes include diecuts which consist of an at least partially unilaterally self-adhesively furnished base layer comprising a heat-resistant carrier, the area of which is greater than the area of the hole to be closed, and which is provided, in particular centrally on the adhesively furnished side, with a first section of a heat-activatable adhesive film, the area of which is greater than the area of the hole to be closed and less than the area of the base layer. The diecut is applied over the hole to be closed in such a way that the hole is covered substantially by the first section. The heat-activatable adhesive films described are highly suitable for sealing, but are comparatively expensive.

The possibility of introducing a component into the diecut, said component fully filling and/or covering the hole at elevated temperature, such as in a drying step, in the painting area, by foaming up, is described in WO 2005/097582 A1. It is found, however, that the unfoamed component must exhibit high expansion in order to ensure full hole closure, since the direction of spread is limited only by the adhesion side to the unilaterally self-adhesive diecut. As a result of this necessary high degree of foaming, the density of material in the resulting hole closure is comparatively low, with adverse consequences for the soundproofing properties. In addition, a hole closure of this kind proves to have only little strength in terms of the adhesion of foam to the metal sheet, since the material makes contact only with the edge of the hole and a little metal sheet on the side facing away from the diecut part. The result of this is a low level of puncture resistance, with puncture resistance being of critical importance to the area of application described.

The intention here is to look more closely at the self-adhesive hole closures, which are required to achieve an acoustic effect.

These acoustically relevant hole closures are often used in assembly in order to obtain an isolated region, the vehicle interior, within the passenger cell. Disruptive acoustics in the vehicle interior are generated, for example, by rolling noises from the tires or else by loose gravel and also small chippings which are thrown against the vehicle paneling and also against the vehicle's structural members. Moreover, wind noises which come about as a result of unstreamlined design are another possible cause of a relatively high, unwanted noise level within the passenger cell.

The noise caused by loose gravel, chips, rolling noises from the tires, and by unevennesses in the ground are often transmitted into the cavities in the structural member systems (side and cross members) and into the vehicle interior or passenger cell. As a result of this, products with acoustic activity must also be employed outside the vehicle. One form of effective acoustic protection, for example, is to tape off holes in the floor assembly or in the vehicle platform. Holes, punched apertures, or drilled apertures are often made in the side and cross members. Here, particular attention must be paid to carefully closing every possible opening.

As already described, numerous holes in the sheet-metal bodywork parts, or in the structural member systems, serve to allow the cathodic electrocoat material to drain as rapidly as possible from the body and from all kinds of cavities, in order to secure operating time. This means, conversely, that the openings and holes must be reliably closed immediately downstream of the cathodic electrocoat dryer. Generally this is done on what is called the PVC line. This area relates to a manufacturing step which takes place before application of primer-surfacer or before application of basecoat material. A further feature to be fulfilled, therefore, is repaintability for products which are employed within this production segment. Moreover, there must be compatibility with PVC seam-sealing material, since gaps are sealed with pumpable PVC compounds between the cathodic electrocoat dryer and the next coating layer.

It is an object of the invention to provide a diecut which is suitable for permanently closing holes, especially in metal sheets or in plastics parts of automobile bodies, and which closes said holes such that moisture penetration is impossible, and which enhances soundproofing and which reliably closes the holes even on stone chipping in the underfloor region and on mechanical stresses within the interior, especially in the floor area, and which in particular produces reliable and durable closing of holes with punching burrs or holes at locations with difficult three-dimensional geometries.

This object is achieved by means of a diecut as specified in the main claim. The dependent claims relate to advantageous onward developments of the subject matter of the invention, and also to a method for permanently sealing holes.

The invention accordingly provides a diecut especially for the permanent closing of holes, particularly in metal sheets or in plastics parts, having a carrier comprising at least one thermosetting plastic, the diecut being self-adhesive at least prior to curing.

Thermosetting plastics (thermosets) are highly crosslinked, infusible polymers such as, for example, phenolic resins or melamine resins, which cannot be processed plastically. For the shaping of the thermosetting plastic, the monomers are introduced into a mold, where they undergo initial crosslinking. After the end of the thermal or photochemical crosslinking, a fully cured, robust plastic is obtained.

Thermosets have a steel elasticity at low temperatures, and even at higher temperatures they are unable to undergo viscous flow, but instead behave elastically with extremely limited deformability. At no temperature does the shear modulus fall below 10⁷ N/m².

According to a first advantageous embodiment of the invention, the diecut consists to an extent of at least 80 wt %, preferably to an extent of at least 90 wt %, more preferably to an extent of at least 99 wt %, with particular preference to an extent of 100 wt %, of the thermosetting plastic.

The diecut here may comprise a single thermosetting plastic. Also possible is the presence in the diecut of a mixture of different thermosetting plastics.

According to one advantageous embodiment of the invention, the curable thermosetting plastic is self-adhesive prior to curing, or a layer of self-adhesive composition is applied at least partially to the carrier.

A self-adhesive, also called pressure-sensitive adhesive (PSA), is an adhesive which even under relatively gentle applied pressure permits a durable bond to virtually all substrates and which after use can be detached from the substrate again substantially without residue. A pressure-sensitive adhesive is permanently tacky at room temperature, thus having a sufficiently low viscosity and a high tack, and so the surface of the bond base in question is wetted by the adhesive under just gentle applied pressure. The bondability of the adhesive derives from its adhesive properties, and the redetachability from its cohesive properties.

In accordance with the invention, the heat-curable adhesive is understood to be a structural adhesive (construction adhesive, assembly adhesive) (see Römpp, Georg Thieme Verlag, document code RD-19-04489, last updating: September 2012). According to DIN EN 923: 2006-01, structural adhesives are adhesives which form bonds which are able to maintain a specified strength for a predetermined, relatively long time span within a structure (according to the ASTM definition: “bonding agents used for transferring required loads between adherends exposed to service environments typical for the structure involved”). They are therefore adhesives for bonds capable of accommodating high chemical and physical stresses, these adhesives contributing in the cured state to the strengthening of the bonded substrates and being used for producing constructions of metals, ceramic, concrete, wood, or reinforced plastics. The structural adhesives of the invention are based in particular on (heat-curable) reactive adhesives (phenolic resins, epoxy resins, polyimides, polyurethanes, etc.).

As mentioned, this heat-curable adhesive may at the same time be self-adhesive prior to curing.

After curing, the curable adhesive may be elastic, in order to ensure a permanent closure which is insensitive to vibrations and twisting.

A pressure-sensitively adhesive thermosetting plastic with particularly advantageous suitability is disclosed in EP 0 877 069 A1.

Accordingly the thermosetting plastic is composed of the following fractions:

15 to 60 wt % of a thermally vulcanizable, polyesterified rubber,
10 to 30 wt % of bitumen and/or tackifying resins,
1 to 20 wt % of vulcanization aids,
0.2 to 5 wt % of vulcanization accelerators,
10 to 70 wt % of fillers, and
optionally further auxiliaries, plasticizers, and oils.

The bitumen and/or the tackifying resins, as for example a terpene-phenolic resin, serve to adjust the pressure-sensitive adhesiveness.

The rubber is preferably the reaction product of a polymer or of a polymer mixture A having on average at least two hydroxyl groups per macromolecule and of an A-compatible polymer or polymer mixture B having on average at least two carboxylic acid groups or at least two carboxylic anhydride groups, or at least one carboxylic acid group and also one carboxylic anhydride group, per macromolecule, with at least one of the polymers, A or B, comprising olefinic double bonds via which the rubber can be vulcanized at elevated temperature under the customary reaction conditions.

In one particularly advantageous embodiment the polymers A and B are liquid polybutadienes which carry on average per macromolecule at least two hydroxyl groups, carboxylic acid groups, or carboxylic anhydride groups.

These functional groups may be bonded terminally at the chain ends or at the ends of the side chains; however, they may also be situated internally on the chain.

Lastly, as further starting constituents, the rubber may feature short-chain, hydroxyl- or carboxylic anhydride- or carboxylic acid-terminated substances. These substances, in relation to polyester formation, function as terminators (monoalcohols, for example), chain extenders (glycols, for example), or crosslinkers (glycerol, for example).

The polyesterification of rubber takes place with further preference through the addition of an esterification catalyst, in a fraction of 0.05 wt % to 0.5 wt %.

Esterification catalysts employed in this context are, in particular, basic esterification catalysts such as amines, preferably secondary and tertiary aliphatic amines, very preferably n-dibutylamine, dimethylcyclohexylamine, diazabicyclooctane, tetramethyl-ethylenediamine, or pentamethyldiethylenetriamine, and also 1-methylimidazole or 1,2-dimethylimidazole.

Vulcanization aids and vulcanization accelerators which have proved to be particularly advantageous include sulfur, 2,2′-dibenzothiazyl disulfide, and, optionally, zinc oxide. The stated substances are added in an amount customary in the context of a vulcanization.

Depending on the specific application it is possible for there to be addition of further fillers such as chalk, carbon black, titanium dioxide, talc, fumed silica, barium sulfate, or calcium oxide, and additionally, as auxiliaries, of oxidation inhibitors, preferably pentaerythrityl tetrakis[3-(3,5-di-tert-butyl-4-hydroxyphenyl)propionate].

Furthermore, the thermosetting plastic may also further comprise system-compatible plasticizers or oils with plasticizer function. Contemplated with preference are commercial phthalate plasticizers or naphthenic oils.

For the preparation, first of all either one of the polymers, A or B, or alternatively both polymers, A and B, are admixed separately from one another with the listed ingredients, under an applied reduced pressure, using a commercial dissolver, planetary mixer, or kneading apparatus.

The resultant components A and B are then mixed together using a 2-component mixing unit and the combined mixture is immediately coated out, on a customary coating unit, on a release paper, to form a pastelike film of any desired thickness, preferably 0.2 mm to 2.0 mm.

In the course of subsequent passage through a heating tunnel, the pastelike mixture undergoes curing to form the pressure-sensitively adhesive film, at a temperature which must be well below the vulcanization onset temperature and is otherwise essentially dependent on the nature and amount of the esterification catalyst and on the speed of passage. The temperature at a speed of passage of 1 m/min to 10 m/min is customarily between room temperature and 80° C.

Thermosetting plastics additionally used are, in particular, reactive, heat-activatable adhesives.

These adhesives possess very good dimensional stability if the elastomeric component has a high elasticity. Furthermore, the reactive resins allow a crosslinking reaction to occur that significantly increases the bonding strength. Thus, for example, heat-activatable adhesives based on nitrile rubbers and phenolic resins can be used, available commercially in the product Tesa® 8401 from tesa, for example.

According to one advantageous embodiment, the thermosetting adhesive consists at least of

a) a polyamide having amino and/or acid end groups,
b) an epoxy resin,
c) optionally a plasticizer,
the polyamide reacting with the epoxy resin at temperatures of at least 150° C., and the ratio in weight fractions of a) and b) being between 50:50 to 99:1.

With further preference the thermosetting adhesive consists of
i) a thermoplastic polymer with a fraction of 30 to 89.9 wt %,
ii) one or more tackifying resins with a fraction of 5 to 50 wt % and/or
iii) epoxy resins with hardeners, optionally also accelerators, with a fraction of 5 to 40 wt %.

This adhesive is a mixture of reactive resins which crosslink at room temperature and form a three-dimensional, high-strength polymer network, and of permanently elastic elastomers which counter embrittlement of the product. The elastomer may originate preferably from the group of the polyolefins, polyesters, polyurethanes, or polyamides, or may be a modified rubber such as nitrile rubber, for example.

The especially preferred thermoplastic polyurethanes (TPU) are known reaction products of polyester polyols or polyether polyols and organic diisocyanates such as diphenylmethane diisocyanate. They are composed of predominantly linear macromolecules. Products of this kind are available commercially usually in the form of elastic pellets, as for example from Bayer AG under the trade name “Desmocoll”.

Through combination of TPU with selected compatible resins it is possible to lower the softening temperature of the adhesive. In parallel with this there is in fact an increase in the adhesion. Examples of resins which have proven suitable include certain rosins, hydrocarbon resins, and coumarone resins.

Alternatively to this, the reduction in the softening temperature of the adhesive can be achieved through the combination of TPU with selected epoxy resins based on bisphenol A and/or F and on a latent hardener. An adhesive comprising a system of this kind allows the joint to harden subsequently, either gradually at room temperature without any further external intervention, or in a short time by means of controlled heating.

As a result of the chemical crosslinking reaction of the resins, high strengths are obtained between the adhesive and the surface to be bonded, and a high internal strength is achieved in the product.

The addition of these reactive resin/hardener systems here also leads to a lowering of the softening temperature of the abovementioned polymers, which has the advantageous effect of lowering their processing temperature and processing speed. The suitable product is a product which is self-adhesive at room temperature or slightly elevated temperatures. On heating of the product, there is also a lowering of the viscosity for a short time, allowing the product to wet even rough surfaces.

The compositions for the adhesive can be widely varied by modifying the nature and proportion of the raw materials. Similarly, further product properties, such as color and thermal or electrical conductivity, for example, can be achieved by specific additions of colorants, mineral and/or organic fillers and/or carbon powders or metal powders.

Nitrile rubbers which can be employed in adhesives of the invention include, in particular, all acrylonitrile-butadiene copolymers with an acrylonitrile content of 15 to 50 wt %. Use may also be made of copolymers of acrylonitrile, butadiene, and isoprene. The fraction of 1,2-linked butadiene here is variable. The aforementioned polymers may be hydrogenated in varying degrees, and fully hydrogenated polymers with a double bond fraction of below 1% can also be utilized.

All of these nitrile rubbers are carboxylated to a certain degree, the fraction of the acid groups preferably being 2 to 15 wt %. Systems of these kinds are available commercially, for example, under the name Nipol 1072 or Nipol NX 775 from Zeon. Hydrogenated carboxylated nitrile rubbers are commercialized under the name Therban XT VP KA 8889 from Lanxess.

To increase the adhesion, the addition of tackifier resins compatible with the nitrile rubbers is also possible.

Epoxy resins are customarily understood to include both monomeric and oligomeric compounds having more than one epoxide group per molecule. These compounds may be reaction products of glycidyl esters or epichlorohydrin with bisphenol A or bisphenol F or with mixtures of these two. Likewise possible for use are epoxy novolak resins obtained by reacting epichlorohydrin with the reaction product of phenols and formaldehyde. Monomeric compounds having two or more epoxide end groups, used as diluents for epoxy resins, can also be used. Likewise possible is the use of elastically modified epoxy resins.

Examples of epoxy resins are Araldite™ 6010, CY-281™, ECN™ 1273, ECN™ 1280, MY 720, RD-2 from Ciba Geigy, DER™ 331, 732, 736, DEN™ 432 from Dow Chemicals, Epon™ 812, 825, 826, 828, 830 etc. from Shell Chemicals, HPT™ 1071 and 1079, likewise from Shell Chemicals, and Bakelite™ EPR 161, 166, 172, 191, 194, etc. from Bakelite AG.

Commercial aliphatic epoxy resins are, for example, vinylcyclohexane dioxides such as ERL-4206, 4221, 4201, 4289, or 0400 from Union Carbide Corp.

Elasticized epoxy resins are available from Noveon under the name Hycar.

Epoxide diluents, monomeric compounds having two or more epoxide groups, are, for example, Bakelite™ EPD KR, EPD Z8, EPD HD, EPD WF from Bakelite AG or Polypox™ R 9, R12, R 15, R 19, R 20 from UCCP.

With further preference the adhesive comprises more than one epoxy resin.

Examples of novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As reactive resins it is also possible, furthermore, to use melamine resins, such as Cymel™ 327 and 323 from Cytec, for example.

As reactive resins it is also possible, furthermore, to use terpene-phenolic resins such as NIREZ™ 2019 from Arizona Chemical, for example.

As reactive resins it is also possible, furthermore, to use phenolic resins such as YP 50 from Toto Kasei, PKHC from Union Carbide Corp. and BKR 2620 from Showa Union Gosei Corp., for example.

As reactive resins it is also possible, furthermore, to use phenol resole resins, including in combination with other phenolic resins.

As reactive resins it is also possible, furthermore, to use polyisocyanates such as Coronate™ L from Nippon Polyurethan Ind., Desmodur™ N3300 or Mondur™ 489 from Bayer, for example.

In one advantageous version of the adhesive of the invention based on nitrile rubber there are additionally bond strength boosting (tackifying) resins added, very advantageously in a fraction of up to 30 wt %, based on the adhesive.

Tackifying resins to be added that can be used include without exception all tackifier resins already known and described in the literature. Those preferentially suitable include non-hydrogenated, partially hydrogenated or fully hydrogenated resins based on indene, rosin and rosin derivatives, hydrogenated polymers of dicyclopentadiene, non-hydrogenated or partially, selectively or fully hydrogenated hydrocarbon resins based on C₅, C₅/C₉ or C₉ monomer streams, polyterpene resins based on α-pinene and/or β-pinene and/or δ-limonene, or hydrogenated polymers of preferably pure C₈ and C₉ aromatics. Any desired combinations of these and further resins may be used in order to adjust the properties of the resultant adhesive in line with requirements. Generally speaking, it is possible to use all resins that are compatible (soluble) with the polymer in question. Express reference is made to the detailing of the state of knowledge in the “Handbook of Pressure Sensitive Adhesive Technology” by Donatas Satas (van Nostrand, 1989).

Besides the acid-modified or acid anhydride-modified nitrile rubbers already mentioned, it is also possible for further elastomers to be employed. As well as further acid-modified or acid anhydride-modified elastomers, unmodified elastomers may also be employed, such as, for example, polyvinyl alcohol, polyvinyl acetate, styrene block copolymers, polyvinyl formal, polyvinyl butyral or soluble polyesters.

Copolymers with maleic anhydride can be employed as well, such as, for example, a copolymer of polyvinyl methyl ether and maleic anhydride, obtainable for example under the name Gantrez™, sold by ISP.

The chemical crosslinking of the resins with the elastomers produces very high strengths within the adhesive.

Further additives which can typically be utilized include the following:
primary antioxidants such as, for example, sterically hindered phenols
secondary antioxidants such as, for example, phosphites or thioethers
in-process stabilizers such as, for example, C radical scavengers
light stabilizers such as, for example, UV absorbers or sterically hindered amines
processing aids
fillers such as, for example, silicon dioxide, glass (ground or in the form of beads), aluminum oxides, zinc oxides, calcium carbonates, titanium dioxides, carbon blacks, metal powders, etc.
color pigments and dyes and also optical brighteners.

Through the use of plasticizers it is possible to increase the elasticity of the crosslinked adhesive. Plasticizers which can be used in the context include for example low molecular mass polyisoprenes, polybutadienes, polyisobutylenes or polyethylene glycols and polypropylene glycols, or plasticizers based on polyethylene oxides, phosphate esters, aliphatic carboxylic esters and benzoic esters. It is also possible, furthermore, to employ aromatic carboxylic esters, diols of relatively high molecular mass, sulfonamides and adipic esters.

Since the nitrile rubbers used, even at high temperatures, do not possess too low a viscosity, there is no escape of the adhesive from the bond line during adhesive bonding and hot pressing. During this operation, the epoxy resins crosslink with the elastomers, producing a three-dimensional network.

Through the addition of what are called accelerators it is possible to achieve a further increase in the reaction rate.

Accelerators may be, for example, the following:
tertiary amines such as benzyldimethylamine, dimethylaminomethylphenol and tris(dimethylaminomethyl)phenol
boron trihalide-amine complexes
substituted imidazoles
triphenylphosphine.

Examples of suitable accelerators include imidazoles, available commercially as 2M7, 2E4MN, 2PZ-CN, 2PZ-CNS, P0505, L07N from Shikoku Chem. Corp. or Curezol 2MZ from Air Products. A further suitable crosslinker comprises additions of HMTA (hexamethylenetetramine).

It is additionally possible optionally to add fillers (for example fibers, carbon black, zinc oxide, titanium dioxide, chalk, hollow or solid glass beads, microbeads of other materials, silica, silicates), nucleators, expandants, bond strength booster additives and thermoplastics, compounding agents and/or aging inhibitors, in the form for example of primary and secondary antioxidants or in the form of light stabilizers.

In a further preferred embodiment the adhesive is admixed with further additives, such as, for example, polyvinyl formal, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers and styrene-butadiene rubbers.

Polyvinylbutyrals are available as Butvar™ from Solucia, as Pioloform™ from Wacker and as Mowital™ from Kuraray. Polyacrylate rubbers are available as Nipol AR™ from Zeon. Chloroprene rubbers are available as Baypren™ from Bayer. Ethylene-propylene-diene rubbers are available as Keltan™ from DSM, as Vistalon™ from Exxon Mobil and as Buna EP™ from Bayer. Methyl-vinyl-silicone rubbers are available as Silastic™ from Dow Corning and as Silopren™ from GE Silicones. Fluorosilicone rubbers are available as Silastic™ from GE Silicones. Butyl rubbers are available as Esso Butyl™ from Exxon Mobil. Styrene-butadiene rubbers are available as Buna S™ from Bayer, as Europrene™ from Eni Chem and as Polysar S™ from Bayer.

Polyvinyl formals are available as Formvar™ from Ladd Research.

In a further preferred embodiment the adhesive is admixed with further additives, such as, for example, thermoplastic materials from the group of the following polymers: polyurethanes, polystyrene, acrylonitrile-butadiene-styrene terpolymers, polyesters, unplasticized polyvinyl chlorides, plasticized polyvinyl chlorides, polyoxymethylenes, polybutylene terephthalates, polycarbonates, fluorinated polymers, such as, for example, polytetrafluoroethylene, polyamides, ethylene-vinyl acetates, polyvinyl acetates, polyimides, polyethers, copolyamides, copolyesters, polyolefins such as, for example, polyethylene, polypropylene, polybutene, polyisobutene and poly(meth)acrylates.

The bond strength of the heat-activatable adhesive can be boosted by further specific additization. Thus, for example, polyimine copolymers or polyvinyl acetate copolymers can also be used as bond strength promoting adjuvants.

For the preparation, the constituents of the adhesive are dissolved in a suitable solvent, butanone for example, and the solution is coated onto a flexible substrate provided with a release layer, as for example a release paper or release film, and is dried, allowing the composition to be removed easily again from the substrate. Following appropriate converting, it is possible for diecuts, rolls, or other shapes to be produced at room temperature. Such shapes are then preferably adhered to the carrier at elevated temperature.

At the laminating temperature, the admixed epoxy resins still do not enter into a chemical reaction, but instead react only at a temperature of 80° C. or more with the acid groups or acid anhydride groups.

The adhesive crosslinks preferably at temperatures above 80° C.

The thermosetting plastic is based preferably on epoxy resins.

Such epoxy resins may be selected from the group of the dimeric, oligomeric, or polymeric epoxides having at least one functional epoxy group. The polymers are materials which comprise epoxy groups, with at least one oxirane ring being polymerizable through a ring-opening reaction. Further possible ingredients, such as catalysts or foaming agents, are known to the skilled person and can be added to the thermosetting plastic.

It is also possible for thermosetting plastics based on polyurethanes, polyacrylates, PVC plastisols, rubbers, or mixtures of different polymers to be used. The skilled person is aware of different crosslinking possibilities for such polymers. In addition to the conventional crosslinking via epoxide groups, it is possible for isocyanates or other vulcanizing agents to be used.

JP 50 028 970 A1 describes an advantageous thermosetting plastic prepared from solution from acrylates and epoxy resin, this plastic initially being pressure-sensitively adhesive and attaining high shear strengths after thermal curing.

WO 95/13328 A1, U.S. Pat. No. 5,086,088 A, and EP 0 386 909 A1 describe advantageous pressure-sensitively adhesive thermosetting plastics which are likewise thermally curable and are based on acrylate/epoxide blends, the acrylates being crosslinked photo-chemically.

The thickness of the carrier layer of the diecut is advantageously between 50 μm and 1000 μm, more advantageously between 100 μm and 500 μm, particularly advantageously between 100 μm and 200 μm.

Also possible in accordance with the invention are diecuts which have a thickness of up to 4000 μm.

In a further preferred variant, a pressure-sensitive adhesive is applied to at least one side of the carrier.

It is possible here to employ all known adhesive systems. Besides natural or synthetic rubber based adhesives there are, in particular, silicone adhesives and also polyacrylate adhesives, preferably a low molecular mass acrylate hotmelt pressure-sensitive adhesive, that can be used.

Preferred adhesives are those based on acrylate or silicone.

The adhesive may be selected from the group of the natural rubbers or the synthetic rubbers, or from any desired blend of natural rubbers and/or synthetic rubbers, with the natural rubber or the natural rubbers being selectable in principle from all available grades such as, for example, crepe, RSS, ADS, TSR or CV products, depending on required level of purity and viscosity, and the synthetic rubber or synthetic rubbers being selectable from the group of the randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA), and polyurethanes, and/or blends thereof.

With further preference the rubbers may have their processing qualities improved by the admixing of thermoplastic elastomers in a weight fraction of 10 to 50% by weight, based on the total elastomer fraction.

Representatives that may be mentioned at this point include in particular the especially compatible styrene-isoprene-styrene (SIS) and styrene-butadiene-styrene (SBS) products. Suitable elastomers for blending are also, for example, EPDM or EPM rubber, polyisobutylene, butyl rubber, ethylene-vinyl acetate, hydrogenated block copolymers made from dienes (for example, by hydrogenation of SBR, cSBR, BAN, NBR, SBS, SIS or IR; such polymers are known as SEPS and SEBS, for example), or acrylate copolymers such as ACM.

In addition, a 100% system based on styrene-isoprene-styrene (SIS) has been found to be suitable.

Crosslinking may be accomplished thermally or by irradiation with UV light or electron beams.

For the purpose of the thermally induced chemical crosslinking it is possible to use all known, thermally activatable chemical crosslinkers such as accelerated sulfur or sulfur donor systems, isocyanate systems, reactive melamine, formaldehyde and (optionally halogenated) phenol-formaldehyde resins and/or reactive phenolic resin or diisocyanate crosslinking systems with the corresponding activators, epoxidized polyester resins and acrylate resins, and also combinations of these.

The crosslinkers are preferably activated at temperatures above 50° C., more particularly at temperatures from 100° C. to 160° C., very preferably at temperatures from 110° C. to 140° C.

The thermal excitation of the crosslinkers may also be accomplished by means of IR rays or high-energy alternating fields.

It is possible to use adhesives with a solvent basis, with an aqueous basis, or in the form of a hotmelt system. An acrylate hotmelt-based adhesive is suitable as well, and may have a K value of at least 20, more particularly greater than 30, obtainable by concentrating a solution of such an adhesive to form a system which can be processed as a hotmelt.

Concentration may take place in appropriately equipped tanks or extruders; especially in the case of accompanying degassing, a devolatilizing extruder is preferred.

One adhesive of this kind is set out in DE 43 13 008 A1, whose content is hereby referenced and is made part of the present disclosure and invention.

The acrylate hotmelt-based adhesive may also be chemically crosslinked, however.

In a further embodiment, self-adhesives used are copolymers of (meth)acrylic acid and the esters thereof with 1 to 25 C atoms, maleic, fumaric and/or itaconic acid and/or their esters, substituted (meth)acrylamides, maleic anhydride, and other vinyl compounds, such as vinyl esters, more particularly vinyl acetate, vinyl alcohols and/or vinyl ethers. The residual solvent content ought to be below 1% by weight.

One adhesive which has likewise shown itself suitable is a low molecular mass acrylate hotmelt pressure-sensitive adhesive, as carried by BASF under the designation acResin UV or Acronal®, more particularly Acronal® DS 3458 or AC Resin A 260UV. This low K value adhesive acquires its application-matched properties by virtue of a concluding crosslinking procedure initiated chemically by radiation.

Finally, it may be mentioned that polyurethane-based adhesives are suitable as well.

For the purpose of optimizing the properties, the self-adhesive employed may be blended with one or more additives such as tackifiers (resins), plasticizers, fillers, pigments, UV absorbers, light stabilizers, aging inhibitors, crosslinking agents, crosslinking promoters or elastomers.

Tackifiers used are the resins already comprehensively described.

Suitable fillers and pigments are, for example, carbon black, titanium dioxide, calcium carbonate, zinc carbonate, zinc oxide, silicates or silica.

Suitable plasticizers are, for example, aliphatic, cycloaliphatic and aromatic mineral oils, diesters or polyesters of phthalic acid, trimellitic acid or adipic acid, liquid rubbers (for example nitrile rubbers or polyisoprene rubbers), liquid polymers of butene and/or isobutene, acrylic esters, polyvinyl ethers, liquid resins and plasticizing resins based on the raw materials for tackifying resins, wool wax and other waxes, or liquid silicones.

Crosslinking agents are, for example, phenolic resins or halogenated phenolic resins, melamine resins and formaldehyde resins. Suitable crosslinking promoters are, for example, maleimides, allyl esters such as triallyl cyanurate, and polyfunctional esters of acrylic and methacrylic acid.

Lastly the diecut may have a covering material with which the diecut is lined until it is used. Suitable covering materials include all of the materials listed comprehensively above.

Preference is given to using a nonlinting material such as a polymeric film or a well-sized, long-fiber paper.

According to one preferred embodiment, the diecut is treated nonadhesively on one side by a surface furnishing. This can be done, for example, by applying a printing, or can be done in the production operation itself, by coating with a material which is not pressure-sensitively adhesive.

A further possibility is that of direct coextrusion of the carrier with a layer of this kind. Another possibility is to combine the thermosetting plastic with a suitable covering, a film for example. Here there are two possibilities which are different in principle. The covering may firstly be selected such that within the temperature range relevant to the application, it softens or melts, or else remains firm. Both versions are advantageous, depending on the specific application scenario.

If the thermosetting plastic is intended to flow as far as possible into the contour of the hole to be covered, an advantage is a soft covering, which optionally also softens or melts. Such a covering may consist, for example, of a film based on PE, PP, PA. The skilled person here is also aware of further possibilities such as laid scrims, nonwoven webs, or fabrics woven from fibers which soften or melt within the application-relevant temperature range.

If the surface of the thermosetting plastic is to be extremely smooth, the covering may be realized in a material which does not soften within the application-relevant temperature range. In this case it is possible, for example, for foils of metal such as aluminum, or films of PET, etc., to be used. Here again, the skilled person is familiar with further possibilities such as laid scrims, nonwoven webs, or fabrics woven from fibers which do not soften or melt within the application-relevant temperature range.

The diecut is preferably furnished on one side with a film.

In one particularly preferred embodiment of the diecut, it is furnished on the lower side with a self-adhesive coating and on the upper side with a film.

The film may consist of any desired polymers, either alone or in a mixture.

Suitable polymers are olefinic polymers such as homopolymers or copolymers of olefins such as ethylene, propylene, or butylene (the term “copolymer” is to be understood here as including terpolymers), polypropylene homopolymers or polypropylene copolymers, including the block (impact) polymers and random polymers.

Further polymers may be selected from the group of the polyesters such as, in particular, polyethylene terephthalate (PET), polyamides, polyurethanes, polyoxymethylene, polyvinyl chloride (PVC), polyethylene naphthalate (PEN), ethylene-vinyl alcohol (EVOH), polyvinylidene chloride (PVDC), polyvinylidene fluoride (PVDF), polyacrylonitrile (PAN), polycarbonate (PC), polyamide (PA), polyethersulfone (PES), polyimide (PI), polyarylene sulfides and/or polyarylene oxides.

These polymers, alone or in a mixture, are also suitable for forming the heavy-duty film.

The upper film consists preferably of polyester (more particularly of polyethylene terephthalate (PET)), polyurethane, or PVC.

Furthermore, it may consist of a laminate of at least two polymeric films, with the lower film having a basis weight of at least 1.5 kg/m².

According to one preferred embodiment of the invention, the lower film has a basis weight of between 1.5 and 6 kg/m², preferably between 1.5 and 3.9 kg/m², more preferably between 1.5 and 2.5 kg/m².

The lower film is preferably a heavy-duty film such as a polyolefin film, more particularly a mineral-filled polyolefin film, or an elastomer-modified bitumen film.

Possible production variants for a heavy-duty film of this kind are extrusion operations or casting operations.

A heavy-duty film consists of a filmlike layer of any desired thickness, more particularly from 0.015 mm up to more than 12 mm, with the heavy-duty film being composed more particularly of thermoplastic polymers, especially PE (polyethylene), EPDM (ethylene-propylene-diene rubber) and/or EVA (ethylene-vinyl acetate), and of mineral fillers, more particularly finely ground limestone or calcite (CaCO₃) and barite (BaSO₄). Additionally used for filling may be talc, finely ground slate, graphite, mica, or asbestos (the latter nowadays less so).

The fraction of fillers is in particular 30 to 90 wt %, preferably 40 to 70 wt %. Expressed as a volume percentage, the fraction is preferably 30 to 60 vol %, more preferably 45 to 55 vol %.

The heavy-duty film may additionally comprise oil for swelling and for better accommodation of the fillers. The oil content may be between 8 vol % to 20 vol %.

The polymers for forming the film and the laminate films may be present in pure form or in blends with additives such as antioxidants, light stabilizers, antiblocking agents, lubricants and processing aids, fillers, dyes, pigments, blowing agents, or nucleating agents. The films preferably have none of the stated additives.

According to a further embodiment, the carrier may also have more than two films.

According to one preferred embodiment, the thickness of the upper film is between 15 and 350 μm, preferably between 30 and 200 μm, more preferably between 50 and 150 μm.

According to one preferred embodiment, the thickness of the lower film is between 600 and 3500 μm, preferably between 1100 and 3500 μm, more preferably between 1700 and 3500 μm.

According to another preferred embodiment, the thickness of the lower film is between 600 and 1100 μm, between 1100 and 1700 μm, or between 1700 and 3500 μm.

In a further advantageous embodiment of the invention, the film is reinforced by integrated and/or attached fibers or filaments, in such a way that the strength of the film is reinforced especially in the longitudinal direction.

For the purposes of this invention, a filament refers to a bundle of parallel individual linear fibers often also referred to in the literature as a multifilament. This fiber bundle may optionally be given inherent strengthening by torsion, and is then referred to as spun or folded filaments. Alternatively the fiber bundle can be given inherent strengthening by entangling using compressed air or water jets. In the text below, for all of these embodiments—and also for the fiber-reinforced embodiment—only the term “filament” will be used, in a generalizing way.

If a film is reinforced exclusively by filaments integrated/attached in the longitudinal direction, the resulting adhesive tapes are referred to as monofilament tapes. In one advantageous development of the subject matter of the invention, the film is reinforced by an open filament fabric. In this case it is referred to as cross-woven filament adhesive tape.

Filaments added are high-strength fibers, folded yarns, folded union yarns, or threads with low elongation at break.

The individual filaments are preferably continuous filaments and/or have a linear density of between 4 and 8 dtex, preferably 5 dtex. In one advantageous embodiment all of the filaments are continuous filaments.

In one preferred embodiment there are between 1 and 30 filaments per centimeter width in the carrier material, more particularly between 1 and 5.

These filaments may consist of organic or inorganic materials, as for example and preferably of glass, carbon, combinations of both types of fiber, aramid fibers or special polyamides, of drawn polymer fibers such as polyester fibers, polypropylene fibers, and polyethylene fibers; furthermore, the reinforcing fibers may be at least partly colored, in order to make the carrier material visually more appealing. In this way it is readily possible to provide for visual differentiation of the reinforced carriers. Colored glass threads or polymer threads are especially appropriate for this purpose.

The film is further preferably laminated with the filaments. The filaments should be firmly connected to the film. This can be done by direct incorporation or insetting of the fibers, threads, folded yarns or folded union yarns into the film, such as by weaving them in the case of wovens, knitting them in the case of knits, or embedding or inserting them in the course of the production process.

Alternatively the filaments may be connected subsequently to the film; for example, mention may be made of their welding or lamination to a corresponding connection layer.

Furthermore, the reinforcements are preferably inserted deliberately in accordance with the direction of stress of the carrier, in other words primarily in the longitudinal direction. Also, however, if more appropriate, they may additionally run in transverse or crosswise direction or, for example, with a curved, spiral, or zig-zag formation, or irregularly.

According to another advantageous embodiment, a support layer is present in the layer forming the carrier, or immediately on and/or under the carrier layer. This support layer may be a support film or a support lattice. In addition to the woven or laid filament fabrics or scrims described above, these may be woven glass-fiber fabrics or laid glass-fiber scrims, on account of their high strength.

By this means it is possible to influence the flow behavior in the context of the application, and to influence the strength after curing. Metal lattices or expanded metals may have a beneficial influence not only on strength but also on things such as conductivity or weldability. Depending on requirement, nonwoven fiber webs or films may also be utilized.

In a further advantageous embodiment, the carrier may foam within the application-relevant temperature range. This foaming may take place either as a result of chemicals which decompose at the application temperature, forming gas, or by means of use of microballoons.

Microballoons are hollow elastic beads which have a thermoplastic polymer shell. These beads are filled with low-boiling liquids or liquefied gas. Shell material used is, in particular, polyacrylonitrile, PVDC, PVC, or polyacrylates. Suitable low-boiling liquids are, in particular, hydrocarbons of the lower alkanes, such as isobutane or isopentane, for example, which are included as a liquefied gas under pressure in the polymer shell. By physical action on the microballoons, in particular by exposure to heat, the outer polymer shell undergoes softening. At the same time, the liquid blowing gas present in the shell undergoes transition into its gaseous state. The microballoons expand irreversibly and three-dimensionally. Expansion is at an end when the internal pressure is balanced by the external pressure. Since the polymeric shell is conserved, the result is a closed-cell foam.

A multiplicity of types of microballoon are available commercially, such as, for example, from Akzo Nobel, the Expancel DU (dry unexpanded) products, which differ essentially in their size (6 to 45 μm diameter in the unexpanded state) and in their required expansion onset temperature (75 to 220° C.). If the type of microballoon and/or the foaming temperature are harmonized with the machine parameters and the temperature profile required for compounding of the composition, it is possible for compounding of the composition and foaming also to take place simultaneously in one step.

Furthermore, unexpanded microballoon products are also available as aqueous dispersions with a solids fraction or microballoon fraction of 40 to 45 wt %, and additionally in the form of polymer-bound microballoons (masterbatches), for example, in ethyl-vinyl acetate with a microballoon concentration of 65 wt %. The microballoon dispersions and the masterbatches, like the DU products, are suitable for the foaming of adhesives of the invention.

For the purposes of this invention, the general expression “diecut” encompasses all sheetlike structures such as two-dimensionally extended films or film sections, tapes with extended length and limited width, tape sections, and the like.

A typical size of the diecut, allowing many of the smaller holes to be closed, is represented by a (circular) disc having a diameter of 10 to 60 mm, more particularly 30 to 40 mm.

The method of the invention for closing a hole especially in a vehicle body with a diecut of the invention is characterized by the following steps:
application of the diecut to the hole to be closed, in such a way that the hole is completely covered by the diecut
causing temperatures of 80° C. to 220° C., more particularly 110° C. to 180° C., and very preferably in the range from 130 to 165° C., to act on the diecut, so that the thermosetting plastic cures and thereby the hole is closed

The diecut withstands even temperatures of, for example, 190° C. or more for several minutes, if for example there is a line fault and the (automobile) bodies stay for longer in the drying ovens.

The curing of the adhesive is preferably accomplished by supply of heat during the customary finishing operation on the bodyshell, more particularly during drying of the paint finish, the underbody protection, or the cathodic electrocoat. In this way there is no need for any additional work cycle.

Sufficient energy is present as a result of the requisite heating of the body during said drying operations.

Alternatively is a local supply of energy by means of thermal or infrared emitters possible.

It is preferred for the diecut to be applied concentrically over the hole to be closed. The contours of the diecut preferably correspond to the contour of the hole to be closed.

In this way the overlap of the individual layers of the diecut is symmetrical. The margin of overlap is preferably between 1 and 20 mm, more preferably between 5 and 10 mm.

The diecut of the invention is superior to the solutions known from the prior art, particularly under heightened mechanical stress.

Furthermore, a single embodiment of the diecut is able to cover a multiplicity of holes of different sizes.

The diecut is distinguished by:
very high load-bearing capacity/puncture resistance
very good sealing with respect to moisture/moisture barrier
effective sealing with respect to noises/sound damping

The puncture resistance is determined by closing a hole with a diecut and subjecting it to targeted puncture. In this case, a pin is clamped into a tensile testing machine, this pin moving at a constant speed toward the horizontally positioned, closed hole and puncturing it to a distance of 30 mm. During this procedure, the force that has to be applied is recorded.

According to one advantageous embodiment of the invention, the diecut has puncture resistances of 200 to 2000 N.

The surface of the diecut part offers an appealing and smooth surface in respect of optical qualities and tactile qualities.

### Test Methods

The measurements are conducted (unless otherwise indicated) under testing conditions of 23±1° C. and 50±5% relative humidity.

### Molar Mass Mn and the Weight-Average Molar Mass Mw

The figures for the number-average molar mass Mn and the weight-average molar mass Mw in this specification relate to the determination by gel permeation chromatography (GPC). The determination is made on 100 μl of sample subjected to clarifying filtration (sample concentration 4 g/l). The eluent used is tetrahydrofuran with 0.1 vol % of trifluoroacetic acid. The measurement is made at 25° C.

The precolumn used is a PSS-SDV-type column, 5 μm, 10³ Å, 8.0 mm*50 mm (statements here and below in the following order: type, particle size, porosity, internal diameter*length; 1 Å=10⁻¹⁰ m). Separation takes place using a combination of the columns of type PSS-SDV, 5 μm, 10³ Å and also 10⁶ Å and 10⁶ Å each of 8.0 mm×300 mm (columns from Polymer Standards Service; detection by means of Shodex R171 differential refractometer). The flow rate is 1.0 ml per minute. Calibration takes place against PMMA standards (polymethyl methacrylate calibration) in the case of polyacrylates and against PS standards (polystyrene calibration) otherwise (resins, elastomers).

The polyacrylates preferably have a K value of 30 to 90, more preferably of 40 to 70, as measured in toluene (1% strength solution, 21° C.). The K value according to Fikentscher is a measure of the molecular weight and the viscosity of the polymer.

### K Value

The principle of the method is based on capillary-viscosimetric determination of the relative solution viscosity. For this purpose the test substance is dissolved by shaking for thirty minutes in toluene, to give a 1% strength solution. In a Vogel-Ossag viscometer at 25° C. the flow time is measured and from this, in relation to the viscosity of the pure solvent, the relative viscosity of the sample solution is ascertained. The K value can be read off from tables by the method of Fikentscher [P. E. Hinkamp, Polymer, 1967, 8, 381] (K=1000 k).

### Glass Transition Temperature

The glass transition temperature is determined by means of dynamic scanning calorimetry (DSC). This is done by weighing out 5 mg of an untreated polymer sample into an aluminum crucible (volume 25 μL) and closing the crucible with a perforated lid. Measurement takes place using a DSC 204 F1 from Netzsch. For inertization, operation takes place under nitrogen. The sample is first cooled to −150° C., then heated to +150° C. at a heating rate of 10 K/min, and again cooled to −150° C. The subsequent, second heating curve is run again at 10 K/min, and the change in the heat capacity is recorded. Glass transitions are recognized as steps in the thermogram.

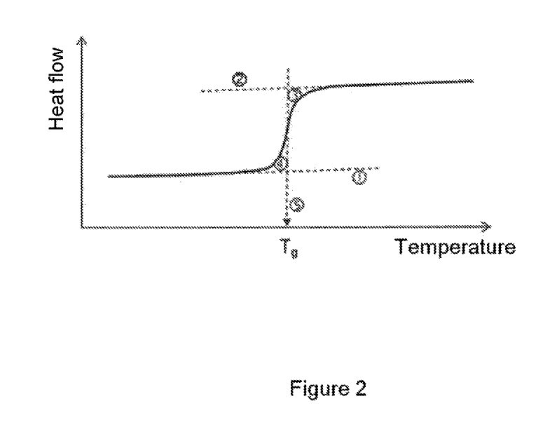

The glass transition temperature is evaluated as follows (see FIG. 2):

A tangent is applied in each case to the baseline of the thermogram before \textcircled{1} and after \textcircled{2} the step. In the region of the step, a balancing line \textcircled{5} is placed parallel to the ordinate in such a way that it intersects the two tangents, specifically so as to form two areas \textcircled{3} and \textcircled{4} of equal content (between in each case a tangent, the balancing line, and the measuring plot). The point of intersection of the balancing lines thus positioned with the measuring plot gives the glass transition temperature.

### Determination of the Puncture Resistance

This test examines the amount of force required to press the diecut component or the plug through the hole that is to be closed. The test may take place either from the side from which the closure means is also applied to the hole, or from the other side. The test surface used is that of uncoated aluminum panels. These panels are cleaned thoroughly with isopropanol and left for 30 minutes for evaporation.

Holes with a diameter of 25 mm are punched from the test panel. The diameter of the diecut components used is 35 mm. These diecut components are applied centrally over the hole and rolled down 5 times using a 4 kg roller at a speed of 10 m/min. For standardization, the test specimens after bonding are stored for 24 hours at 23±1° C. and 50±5% relative humidity. The test is performed with a standard tensile testing machine, fitted with a die 8 mm in diameter. The force measured is reported in N/cm.

### Determination of the Resistance to Damage by Sharp Objects

The test is performed in the same way as for the determination of the puncture resistance, except that in this case a sharp pin of 2 mm is used instead of an 8 mm-diameter die. The pin converges to a point at the end over a length of 15 mm. A determination is made of the force required in order to press a hole into the test body.

Below, on the basis of a figure, the diecut for the permanent closing of holes especially in metal sheets or in plastics parts of automobile bodies is to be elucidated in more detail, without any intention of a restrictive effect in any form.

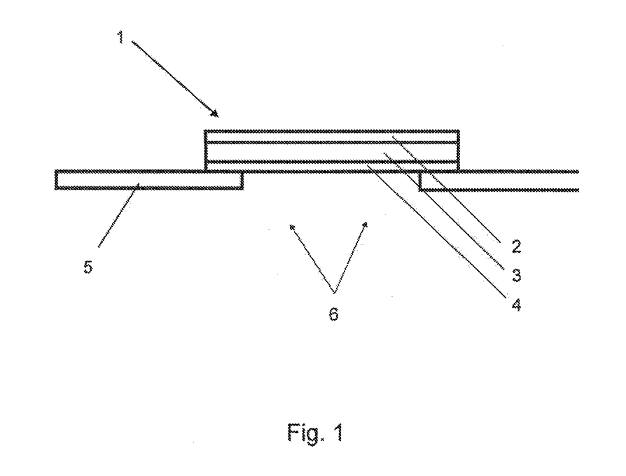

FIG. 1 shows a hole in a body that is to be closed, and also the state after which thermal exposure has closed the hole that was to be closed.

The body 5 contains, as a result of its construction, a hole 6, which is to be closed.

For this purpose, a diecut 1 with a carrier 3 lined on the upper face with a film 2 and coated on the lower face with a self-adhesive composition 4 is fixed on the hole 6 in such a way that the hole 6 is covered fully by the diecut 1.

The area of the diecut 1 is greater than the area of the hole 6 to be closed.

The diecut 1 is joined permanently to the bodywork 5 by subjecting the diecut briefly to high temperatures that lead to the activation of the carrier 3.

### EXAMPLES

### Example 1

A self-adhesive thermosetting plastic based on epoxides (available as product L-5001R from L&L, for example) is processed into a diecut component 35 mm in diameter. This diecut component is furnished on one side with a nonadhesive layer. At the application temperature, this nonadhesive layer undergoes softening. The diecut component is applied centrally to an aluminum panel cleaned as described above, and is crosslinked for 30 minutes at an oven temperature of 160° C.

### Example 2

In deviation from example 1, an aluminum foil 30 μm thick and furnished with an acrylate-based pressure-sensitive adhesive (Tesa® 50525) is laminated to the nonadhesive side of the product L-5001R.

### Example 3

In deviation from example 1, an aluminum wire fabric (mesh size 1.4/wire diameter 0.26/b=1000), obtained from Modulor GmbH, is introduced into the thermosetting plastic.

### Comparative Example 1

The product Tesa® 54657 is applied as a diecut in 35 mm thickness as in example 1.

### Comparative Example 2

The product Tesa® 54338 is applied as a diecut in 35 mm as in example 1

### Comparative Example 3

A plug from ITW Delfast is applied into a hole with 25 mm and subjected to the corresponding tests. In deviation, the panel is not heated to 160° C., but is instead stored at RT for 24 hours.

| | Comp. | Comp. | Comp. | | | |
|---|---|---|---|---|---|---|
| | ex. 1 | ex. 2 | ex. 3* | Ex. 1 | Ex. 2 | Ex. 3 |
| Puncture resistance | 9 | 4 | 23 | 48 | 54 | 72 |
| (pointed pin) [N] | | | | | | |
| Puncture resistance | 340 | 674 | 85 | 102 | 275 | 159 |
| (measured from the | | | | | | |
| side of application) | | | | | | |
| [N] | | | | | | |
| Puncture resistance | 105 | 122 | 69 | 139 | 202 | 189 |
| (measured from the | | | | | | |
| underside) [N] | | | | | | |

1. A diecut for the permanent closing of one or more holes in at least one selected from metal sheets and plastics parts, the diecut comprising a carrier comprising at least one thermosetting plastic, wherein the diecut is self-adhesive at least prior to curing.

2. The diecut according claim 1, wherein the diecut consists to an extent of at least 80 wt % of the thermosetting plastic.

3. The diecut according claim 1, wherein the diecut is self-adhesive prior to curing, or a layer of self-adhesive composition is applied to the diecut at least partially, the diecut being furnished on at least one side with a self-adhesive coating.

4. The diecut according to claim 1, wherein the diecut is furnished on one side with a film.

5. The diecut according to claim 1, wherein the diecut is furnished on the lower side with a self-adhesive coating and on the upper side with a film.

6. The diecut according to claim 1, wherein, in the layer forming the carrier, or immediately on and/or below the carrier layer, there is a support layer.

7. The diecut according to claim 2, wherein the thermosetting plastic is composed of the following fractions:
15 to 60 wt % of a thermally vulcanizable, polyesterified rubber,
10 to 30 wt % of bitumen and/or tackifying resins,
1 to 20 wt % of vulcanization aids,
0.2 to 5 wt % of vulcanization accelerators,
10 to 70 wt % of fillers, and
optionally further auxiliaries, plasticizers, and oils.

8. The diecut according to 2, wherein the thermosetting plastic is based on epoxy resins.

9. The diecut according to claim 1, wherein thickness of the carrier is between 50 μm and 500 μm.

10. The diecut according to claim 1, wherein the diecut is applied concentrically over the hole to be closed.

11. The diecut according to claim 1, wherein contours of the diecut correspond to a contour of the hole to be closed.

12. A method for closing a hole with the diecut according to claim 1, the method comprising:
applying the diecut to the hole to be closed such that the hole is covered by the diecut,
causing temperatures of 80° C. to 220° C. to act on the diecut for 15 minutes or more, so that the heat-activatable adhesive cures and thereby the hole is closed.

13. The method as claimed in claim 12, wherein contours of the diecut correspond to a contour of the hole to be closed, such that the margin of overlap by the diecut is between 1 and 20 mm.

14. A hole especially in a vehicle body with the diecut according to claim 1.

15. The diecut according to claim 2, wherein the diecut consists to an extent of 100 wt % of the thermosetting plastic.

16. The diecut according to claim 9, wherein thickness of the carrier is between 100 μm and 200 μm.

17. The method according to claim 13, wherein the margin of overlap by the diecut is between 5 and 10 mm.
